(19) United States
(12) Patent Application Publication
(10) Pub. No.: US 2011/0191132 A1
(43) Pub. Date: Aug. 4, 2011

(54) METHOD FOR ANALYSING BUSINESS SOLUTIONS

(75) Inventors: Craig Westcott, Melbourne (AU); Xavier Russo, Melbourne (AU)

(73) Assignee: Software Shortlist Pty Ltd., Melbourne (AU)

(21) Appl. No.: 13/122,148

(22) PCT Filed: Nov. 5, 2009
(86) PCT No.: PCT/AU2009/001437

§ 371 Date: Mar. 31, 2011

Related U.S. Application Data
(60) Provisional application No. 61/111,480, filed on Nov. 5, 2008.

(30) Foreign Application Priority Data
Nov. 5, 2008 (AU) 2008905700

(51) Int. Cl. G06Q 10/00

(52) U.S. Cl. 705/7.11

(57) ABSTRACT

A system compares a plurality of business solutions by receiving one or more solution requirements from a user and creating a subset of at least one solution based on the user's solution requirement(s). If the subset comprises a plurality of solutions; (a) the solutions within the subset are prioritised based on the fit of each to the user's solution requirements and (b) optionally, a means for the user to compare the selected solution is provided.

### BACKGROUND TO THE INVENTION

Many businesses depend on software and related business IT solutions to operate efficientfy and effectively in their chosen market. It is increasingly critical for success to choose an appropriate solution and ensure its proper installation, maintenance and operation. However, the large number of solutions available—tens of thousands of software packages alone, plus hardware and service options—can be overwhelming, and many businesses lack the time, expertise, or inclination to properly assess and compare solutions in order to make an informed decision.

A prospective purchaser has to grapple with some or all of the following sources of complexity, which are explained in more detail in the section below:
Composition of solution
Number of solutions available
Feature confusion and ambiguity
Different pricing structures
Nature of ownership or usage

### Composition of Solution

A variety of business IT solutions are offered to customers by software vendors, hardware vendors and service providers. These solutions typically comprise software, hardware or IT support services components, or any combinations of these. Many of the solutions on offer are a bundled combination of these three components, sourced from one or more vendors. This reflects customer demand for “one-stop-shops” and end-to-end solutions.

For large solutions, it is quite common to have significant service components in a solution, including design, installation, integration, training, and maintenance. Nonetheless, even small or specialist businesses that purchase stand-alone software often enter into additional agreements for software upgrades, bug fixes, help desk support, training, and similar support services.

### Number of Solutions Available

There are tens of thousands of software packages available around the world, produced by software developers ranging from single-person entities through to massive corporations. Add to this the large number of hardware and service options, and the various bundled combinations of all three, and it is clear that the prospective customer has an enormous array of solutions to choose from. The infrequent purchase of business IT solutions limits the customer's ability to manage this breadth of choice, and the cost of getting it wrong can be substantial.

### Feature Confusion and Ambiguity

A lack of common standards and an abundance of vendor-specific terminology can make it difficult for customers to assess and compare business IT solutions. It is quite common for vendors to offer similar functionality but refer to it by different names; or for providers to use similar words for distinctly different offerings. This can create significant confusion for the prospective customer.

### Different Pricing Structures

The pricing structure of software solution options available today is complex and varied. Prices are dependent upon a diverse set of variables, such as: functionality included in the software (typically functional modules); the number of users accessing the system; the number of servers that the software is running on; additional hardware components required; services or software/hardware support options elected; etc.

Software vendors and service providers offer various combinations of one-off and recurring fee structures (including both monthly and annual payments) to cover these various requirements.

### Nature of Ownership or Usage

Business IT solutions available today are typically available in one of three major ways:
Packaged solutions
Hosted or Software as a Service (SaaS) solutions
Custom solutions.

Packaged solutions are offered as bundled configurations of software, hardware and/or services components, and are installed in-house on a customer's own computer system. These software solutions are either downloaded from the internet, if practical, or are sent to the customer on a disk for installation on their system. Customers typically receive a license to use this software indefinitely, and sometimes enter into a separate software support agreement with the vendor.

Hosted or Software as a Service (SaaS) solutions are offered as bundled configurations of software, hardware and/or services components, and are installed on the vendor's or service provider's computer system (hosted). A customer may usually select their preferred options on the internet, make payment and gain immediate access to the service on offer. The licensing agreement is usually time-dependent and includes services.

Custom solutions are purpose built on request from a customer, and are typically developed to be run in-house on the customer's systems. Often they are bundled configurations of software, hardware and/or services components, although usually with a small (or nil) software license fee and a large services component for developing the custom solution. Ownership of the software may vest in the customer, depending on the agreement. Providers may also offer customers services-centric support agreements once the solution is completed.

FIG. 1 illustrates the different fee structures, and ownership or usage rights, for the three software solution options discussed above.

Before deciding on an appropriate business IT solution, the prospective customer needs to make sense of the complexity described above to assess which options are right for their specific needs. There are various ways in which this is currently managed, including software selection consulting services, online search methods, and ad-hoc advice from contacts.

Current methods seek to address the above problems in a number of ways, such as: generic search engines; packaged and open source software download websites; software directory websites; software review websites; and vendor websites.

### Generic Search Engines

A major source of information about business software, along with most other content on the internet, is search engines. Customers spend a lot of time on search engines searching for software using different search terms. Through a combination of organic and paid search results that appear, customers are able to link to vendor websites and software directories to perform more detailed research about software products.

The key issue that customers find in utilizing search engines is the amount of irrelevant information that needs to be reviewed in order to find relevant results. It is not uncommon for customers to spend weeks searching for relevant software that meets their specific needs. In many cases, customers give up and decide to develop their own software even though appropriate products may exist. The invention described herein overcomes this issue by gathering the customer's key requirements quickly and providing relevant results immediately.

### Software Download Websites

Software download websites offer software packages that customers are able to find, download and purchase online. These web sites offer ‘productized’ software packages for download and purchase, often in the form of free trials or shareware. These packages are standardized and typically take a ‘one-size-fits-all’ approach, with no remaining variables that alter the cost. As such, the software is sold as packaged software through many channels/websites. Users of the websites often contribute to how the software is ranked, in the form of user ratings, download statistics and the like. Sometimes editors or experts will contribute reviews or assemble lists of recommended software.

In the case of this prioi art, only software that has already been ‘packaged’ and presented as a simple transaction can be downloaded. Existing download websites are not capable of handling complex multi-variable solutions or pricing arrangements. Comparison and assessment remains labour-intensive for the user and any recommendations are general, not tailored to the specific user. Some embodiments of the invention described herein addresses these shortcomings through a number of techniques, including solution bundles, comparison pricing, and real-time recommendations tailored for each customer.

### Software Directory and Aggregator Websites

There are numerous software directory and aggregator websites globally. These websites store general information about each product that is listed (typically a page explanation about the product generally or a software website link), and provide a means for customers to browse the software in the directory or search based on keywords/categories. The software search facilities provided by one such directory allows customers to browse by industry or software type, and then to refine the search using further criteria such as number of users, location or functionality required (modules).

On each of these directories/aggregators, the solutions listed range from actual packaged offerings that may be downloaded and bought off the vendors' websites (i.e. fixed price offerings) to software solutions that require a lot of input from the vendor before a configuration and pricing can be fixed (i.e. many variables). Software as a Service (SaaS) products listed typically contain high-level product information and may contain pricing listed as a recurring amount or combination of a recurring amount and up-front amount. There is little or no consistency between different solutions listed from a comparison perspective.

Software that is listed in directories may, in some cases, contain an estimated price for the software, although consistency on this aspect this may vary within the same directory. This price is usually represented as a typical solution price range (min/max) or as an estimated cost, and will be displayed in the payment structure that has been defined by the supplier (i.e. some solutions are displayed as monthly/annual subscription costs and others as one-off costs—they vary depending upon the solution listed).

As with the software download websites above, software directories do not provide a means of simplifying all solutions available for comparison purposes. The invention described herein improves on the prior art by using bundles to calculate or represent actual solution costs over a period of time for each solution, and by providing real-time recommendations tailored for each user. This combination of principles allows for more reliable comparisons to be made between solutions.

### Software Review Websites

Software review websites are typically content-driven websites that promote discussion around software solutions for specific markets. These websites will usually publish content around represented solutions for general business requirements, such as suggested CRM solutions, and/or ‘top solutions reviewed’ listings. Customers are presented with content and information around various solutions available in the form of articles, brochures, and the like, and/or the sites may provide reviews of the solutions themselves. In the case of one such review website, software reviews are presented for their top recommended solutions and a ‘lowest’ price is shown for each solution.

Unlike certain embodiments of the invention described herein, the solutions and costs presented in these review sites are generic for the software shown, and only contain a comparison for a ‘typical or lowest cost average software package’. Review sites have no means of providing accurate solution and cost comparisons based on the customers' requirements, nor a means of comparing actual bundled software, hardware and services across solutions—only possible software costs. Finally, such sites also have no concept of a single amount used for accurately comparing the actual cost of complex solutions over time.

### Vendor Websites

Finally, vendor websites exist that allow vendors to represent and sell their software online. In some cases, it is possible for a customer to find an accurate cost for their required solution—either for downloadable packaged software or where customers are able to enter their requirements and get a cost (typically for SaaS software). These vendors may also provide comparisons between their software products, or between their software and competitors' software, in a tabular form.

Both the bundling approach discussed above and the ‘single amount cost comparison over time’ are not catered for in vendor websites. More generally, vendor websites do not provide a relevance comparison and recommendation facility across solutions available in the market.

The reference to any prior art in this specification is not, and should not be taken as, an acknowledgement or any form of suggestion that the prior art forms part of the common general knowledge.

### SUMMARY OF THE INVENTION

In a first aspect of the invention, there is provided a method for comparing a plurality of business solutions comprising: receiving one or more solution requirements from a user; creating a subset of at least one solution based on the user's solution requirement(s); if the subset comprises a plurality of solutions then; (a) prioritizing the solutions within the subset based on the fit of each to the user's solution requirements; and (b) optionally providing a means for the user to compare the selected solutions. In some embodiments, there is the further step of creating a set of solutions, based on at least one solution characteristic.

Some embodiments of the invention further comprise one or more of the following: representing each solution as at least one of software, hardware and/or IT services components, and optionally wherein the configuration of the solution defines all cost-dependent variables for each solution; defining features of each solution in the set, wherein the features are features of at least one solution in the set; defining benefits of the solutions, wherein the benefits are common to all solutions in each group and optionally comprise key benefits to a user of the solution such as: ease of use, low cost, flexible to customize, ease of learning, feature/function fit, customer feedback and the like.

In some embodiments, there are further provided the steps of selecting at least one solution based on the user's solution requirements; and displaying the selected solutions based on said prioritization.

Step b described above may comprise using information defining the user's solution needs and optionally comprise (i) key features and benefits, (ii) user location(s), (iii) number of users, (iv) number of installations and the like.

The solutions may be published for the purpose of comparing and benchmarking any combination of the software, hardware and IT services components by internet, software, hardware or services organisations.

Configuration may cornrOise a bundle of any combination of software, hardware and IT services supplied by at least one of a plurality of suppliers under at least one agreement, arrangement, contract or the like.

Each set of solutions may be classified by at least one combination of industry and soft-ware type parameters. In some embodiments, each combination of industry and software type parameters comprises a combination of industry, sub-industry, software type and software sub-type classification parameters.

The features of the entities may comprise functional aspects of the solutions that users desire in meeting their requirements, said features being specified for the group being selected.

The step of gathering solution requirements from a user may comprise prioritizing, selecting and displaying specific key features from the set of all features of the entities within the same group, and optionally the method comprises one or more of: for each feature, calculating a ‘feature percentage’, the feature percentage optionally comprising the proportion of entities within the group containing that feature; defining a ‘marginal percentage’ for the group, the marginal percentage representing the preferred percentage of entities in the group in which a feature should exist; prioritizing the features of the entities within the group, based on the proxithity of the feature percentage to the marginal percentage for each feature; and selecting and optionally displaying key features to the user for said group based on the prioritization of the features of all entities.

In some embodiments of the invention, the process of prioritizing the features of all entities within the group based on the proximity of the feature percentage for each feature to the marginal percentage involves: for each feature, calculating the difference between the feature percentage and the marginal percentage using the following formula:

Feature Differenceₙ=|(feature % for featureₙ)−(marginal % for group)|

where: n=feature number
prioritizing features based on a minimization of said feature difference; and utilizing these priorities in the selection and display of key features.

There may also be provided the step of selecting and displaying specific features comprises displaying a select number of features that have the highest priority.

In some embodiments, the step of gathering solution requirements from a user comprises a method of obtaining importance rankings for benefits of the entities, the method comprising one or more of: setting a default rank order of importance for the benefits of the entities; displaying the benefits of the entities to a user who is optionally entering solution requirements in said default tank order of importance; gathering a preferred rank order of importance of said benefits from the user and optionally while the user is entering solution requirements; and utilizing the preferred rank order of importance of said benefits in selecting and/or prioritizing recommended entities that meet or approximate a specific user requirement.

Step c described above may further comprise a process of selecting and prioritizing at least one solution based on the user's solution requirements, the process comprising: gathering solution requirements from the user, including but not limited to the required group, user locations, number of users, number of installations, support requirements, budgetry estimates, key features and benefits and the like; selecting at least one solution meeting minimum eligibility criteria in the user's solution requirements; for each solution meeting said eligibility criteria, generating both user-specific and default relevance scores based on closeness of fit to user requirements; generating a coriabiried overall relevance score for each solution; and prioritizing the entities based on said relevance scores and displaying the entities in order of priority.

The combined overall relevance score for each solution may be generated as an aggregation of the user-specific and detail relevance scores for said solution taken in defined proportions. In some embodiments, user-specific and default relevance scores are generated for each solution, based on an accumulation of scores generated for each benefit of the entities.

Scores for each benefit of the one or more entities may be generated either through user ratings of the benefit of the respective solution or through system calculation of the benefit of the solution based on fit to user requirements. In some implementations or embodiments, the means for the user to compare or benchmark the displayed entities comprises a means of comparison or benchmarking the payment amounts of any number of the entities over a period of time. In some embodiments, the means of comparison or benchmarking the payment amounts comprises defining a cost-dependent variable for each solution such that each solution configuration has a fixed cost over a period of time, said fixed cost optionally being used for comparison purposes and optionally termed Comparison Price.

The payment amounts for each solution may be calculated as Present Values (PV) of all payments associated with each solution over a period of time, and are optionally represented in a common currency.

In another aspect of the invention, there is provided a method for comparing one or more entities, wherein the entities consist of any combination of software, hardware and IT services components and at least one solution contains two or more associated cost installments, the method comprising: representing each solution as a solution of at least one of the software, hardware and IT services components, and optionally wherein the configuration of the solution defines all cost-dependent variables for each solution; representing the cost of each solution as a single amount, wherein the amount reflects all cost installments of the solution over the period of time; calculating or retrieving the amounts for at least one of a set of the entities; and comparing or benchmarking the amounts for one or more of the entities.

In some embodiments of this aspect of the invention, the method for comparing entities comprises a method for determining and comparing the costs of entities over a period of time. In some embodiments, the cost-dependent variables are defined such that the solution configuration has a fixed cost over the period of time. In some embodiments, the cost-dependent variables comprise one or more of defined system functionality and modules; specified number of users; specified number of software licenses; defined hardware components; an estimated life of the customer; and the like.

The single amount of this aspect of the invention may represent the overall cash flow amount of any combination of cash flow installments constituting the payment structure for the solution over the period of time. In some embodiments, the single amount is a non-recurring single amount. In some embodiments, the single amount is specified at a defined point in time and represents all cash flow installments for the solution over the period in time. In some embodiments, the single amount is the Present Value (PV) of the cash flows of all the installments constituting the cost of each solution, at a defined interest rate over the period of time, as determined using the Discounted Cash Flow (DCF) formula for the cash flows:

$$PV = \sum \frac{{C}_{t}}{{( 1 + {r}_{t} )}^{t}}$$

where: t=time in years
rₜ=annual interest rate or opportunity cost over time t
cₜ=cash flow at time t

The instalments constituting the cost of each solution may comprise any combination of all cash flows pertaining to the payment structure for the solution, including payments, discounts, rebates, vouchers, special offers and the like. In some embodiments, the installments representing the cost of the solution more specifically comprise any combination of one-off payments, on-going subscription payments and rebates for the purchase, lease or rental of the software, hardware and IT services over the period of time. In some embodiments, the installments represent a multi-payment schedule for the purchase, lease or rental of the solution.

The amount representing the cost the solution may be retrieved or calculated for any number of entities and utilized as an element in the comparison or benchmarking of the entities. In some embodiments, the elements used in the comparison of the entities comprise costs; functionality within each solution; benefits of each solution; number of users; and the like. In some embodiments, the entities are compared with other entities utilizing at least the cost of the entities.

The entities may be benchmarked against other data for analysis purposes.

The amount representing the cost of the solution may comprise a combination of single cost installments or multiple cost installments over a period of time.

According to a still further aspect of the invention, there is provided a method for comparing a set of business solutions comprising real-time identification of a subset of relevant solutions.

According to the present invention, characteristics of the set of business solutions may be maintained up to date in real time and optionally by one or more of (a) solution suppliers, (b) expert assessment, or (c) customer reviews.

In another aspect of the invention, there is provided a method for comparing a set of business solutions comprising providing for a subset of solutions a single comparison cost that reflects for each member of the subset all relevant costs over a period of time.

The method of this aspect of the invention may provide that the single cost is a Present Value (PV) of cash flows of all the costs of each solution, at a defined interest rate over a period of time, as determined using a Discounted Cash Flow (DCF) formula for the cash flows and wherein the formula is optionally:

$$PV = \sum \frac{{C}_{t}}{{( 1 + {r}_{t} )}^{t}}$$

where: t=time in years
rₜ=annual interest rate or opportunity cost over time t
cₜ=cash flow at time t

In a further aspect of the invention, there is provided a system for comparing a plurality of business solutions comprising: a user interface; a module to gather solution requirements from a user; a module to create a subset of at least one solution based on the user's solution requirements; a module to prioritize the solutions within the subset based on the fit of each to the user's solution requirements; and optionally a module to provide a means for the user to compare the selected solutions.

In another aspect of the invention, there is provided a system for comparing one or more entities, wherein the entities comprise any combination of software, hardware and IT services components and at least one solution contains two or more associated cost instalments, the system comprising: a user interface; a module to calculate cost information as herein described; a module to compare or benchmark the amounts for any number of the entities.

In another aspect of the invention, there is provided a system for comparing a set of business solutions comprising a module to perform real-time identification of a subset of relevant solutions.

In another aspect of the invention, there is provided a system for comparing a set of business solutions comprising a module to generate for a subset of solutions a single comparison cost that reflects for each member of the subset all relevant costs over a period of time

In some embodiments, the single cost is a Present Value (PV) of cash flows of all the costs of each solution, at a defined interest rate over a period of time, as determined using a Discounted Cash Flow (DCF) formula for the cash flows and wherein the formula is optionally:

$$PV = \sum \frac{{C}_{t}}{{( 1 + {r}_{t} )}^{t}}$$

where: t=time in years
rₜ=annual interest rate or opportunity cost over time t
cₜ=cash flow at time t

Each set of solutions may be classified by at least one combination of software type parameters. In some embodiments, each combination of software type parameters comprises a combination of software type and software sub-type classification parameters. In some embodiments, a customer may make a payment prior to the selected solutions being displayed by the system. In some embodiments, a customer may register as a user on the web site prior to the selected solutions being displayed by the system. In some embodiments, there is further provided a module to receive payment from the user prior to the user comparing the selected solutions. In some embodiments, there is provided a module for the user to register on the website prior to the user comparing selected solutions.

The invention is based around a number of elements, including real-time or near real-time identification of the most relevant subset of solutions for a given customer; using bundles to simplify how solutions are represented in an information system for comparison purposes; and determining a single comparison cost that reflects all costs over a period of time. The invention also efficiently gathers user requirements and preferences, such as focusing on marginal features and rank ordering the importance of various software benefits.

By combining these and other elements, the disclosed invention enables a prospective customer to quickly and easily identify the most relevant business IT solutions for their needs, and then assess, compare and benchmark this subset in order to reach a well-informed purchase decision.

Throughout this specification (including any claims which follow), unless the context requires otherwise, the word ‘comprise’, and variations such as ‘comprises’ and ‘comprising’, will be understood to imply the inclusion of a stated integer or step or group of integers or steps but not the exclusion of any other integer or step or group of integers or steps.

### BRIEF DESCRIPTION OF THE DRAWINGS

FIG. 1 is a table showing the fee structure for typical software solution options that are available on the market, demonstrating the diverse solution options and pricing models available.

FIG. 2 depicts software recommendation facility algorithm according to one aspect of the invention, showing the context in which the disclosed invention is utilized.

FIG. 3 depicts a process flow for short-listing and selecting products as part of product setup according to one aspect of the invention.

FIG. 4 depicts a process flow according to one aspect of the invention in which a user commences software selection on a website.

FIG. 5 depicts a process flow according to one aspect of the invention for a user to specify features and to prioritize benefits, and for the system to score and deliver recommended results.

FIG. 6 depicts a process flow according to one aspect of the invention for a user to act on the recommended results delivered.

FIG. 7 is a table illustrating the concept of “marginal features”, used in the display of the most relevant features as a user enters requirements.

FIG. 8 is a table illustrating the application of the Comparison Price claimed in this invention to three sample solutions A, B and C.

### DETAILED DESCRIPTION OF THE INVENTION

It is convenient to describe the invention herein in relation to particularly preferred embodiments. However, the invention is applicable to a wide range of circumstances and it is to be appreciated that other constructions and arrangements are also considered as falling within the scope of the invention. Various modifications, alterations, variations and or additions to the construction and arrangements described herein are also considered as falling within the ambit and scope of the present invention.

In some embodiments, the invention is a method for recommending and comparing business IT solutions and preferably in real-time. It resolves at least some and preferable many of the difficulties customers face when using prior art methods to select an appropriate business IT solution.

In some embodiments, the invention includes a number of elements, including real-time identification of the most relevant subset of solutions for a given customer; simplification of how solutions are represented in an information system for comparison purposes; and representation of a single comparison cost that reflects all costs over a period of time. By combining these and other elements, the invention enables a Customer to quickly and easily identify the most relevant business IT solutions for their needs, and then assess, compare and benchmark this subset in order to reach a well-informed purchase decision.

In one embodiment of the invention, a website provides the interface for users to complete an online survey of their requirements and preferences, and to view and compare the “recommended” subset of solutions. A plurality of in formation types may be provided for each recommended solution, together with the functionality for the user to perform various actions such as buying the solution, visiting the websites of the vendor(s), downloading a trial version, or requesting to be contacted by a vendor.

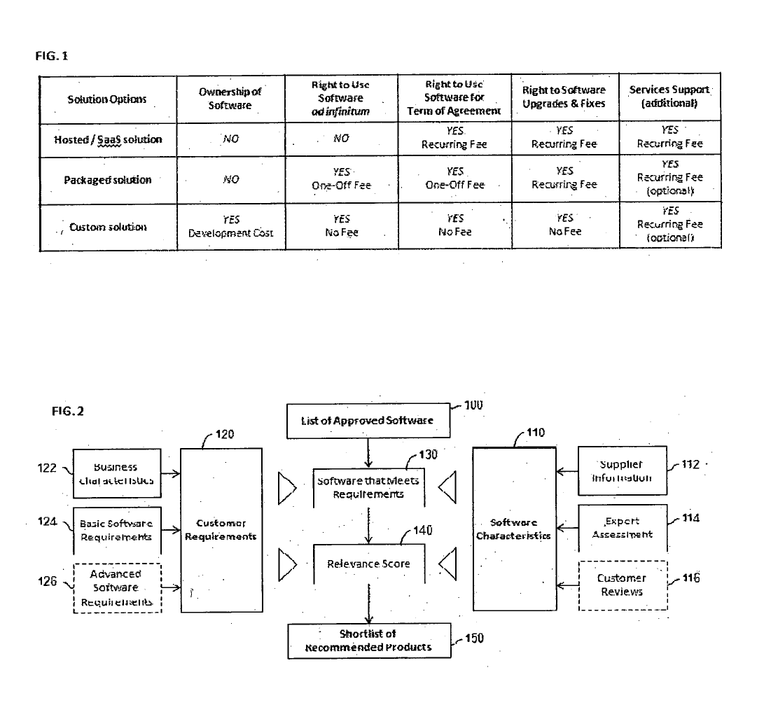

Referring now to FIG. 2, a high-level overview of an example recommendation process is depicted. A set of approved solutions [100] is assembled, for which detailed information about the solution and its characteristics [110] has been gathered and organized, including data from vendors [112], experts and editors [114], and/or users of the solution [116]. An online interview process is then used to define the user's requirements [120], including a consideration of their business characteristics [122], the type of software they need [124], and their detailed requirements or preferences regarding functionality, support and other factors [126]. A subset of “eligible” solutions is identified [130] that meet the minimum requirements of the user, and a relevance score [140] is calculated for each solution based on how well it fits the specific requirements and preferences of the user. Eligible solutions are then sorted by relevance score, and a number of the top scoring solutions are presented in a shortlist [150] to the user for their review, comparison, and action.

The characteristics of each solution under analysis may also be given weightings based on suitable preferences. For example, features which are on average more important to end users for a given type of solution may be given a higher weighting for the purposes of the comparison. Thus, for example, ease of use (for example, as measured by average amount of training required) may be given a high weighting for software to be used by time-poor professionals. Thus, a solution with a higher rating in this characteristic will have its overall rating magnified by scoring well in this feature. Such weightings allow the process to be more focused around the most important needs of the intended end user.

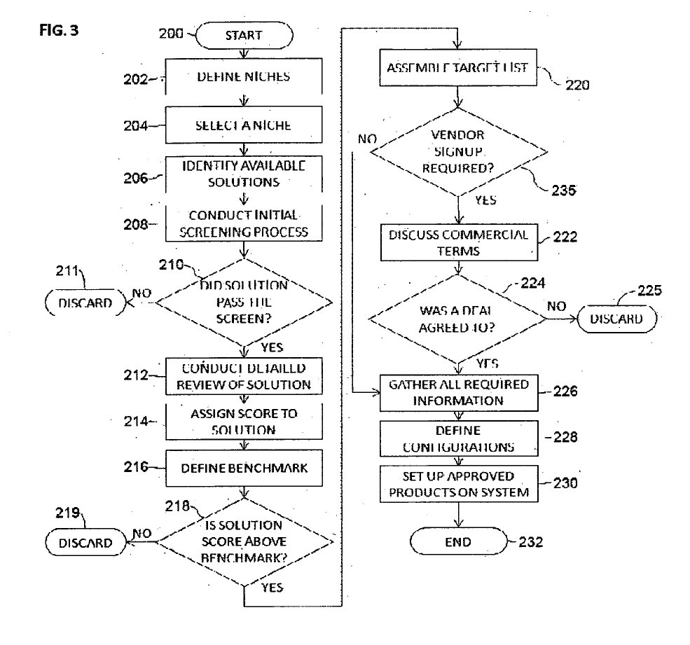

FIG. 3 depicts a sample process by which an approved set of solutions may be defined. A plurality of niches [202] are defined, each comprising the intersection of an industry sector and a software type. For each niche, a search is undertaken to identify a broad list of available software [206], using a range of methods and data sources established in the prior art. A multi-stage assessment process is conducted, including an initial screen [208] for quality indicators, a more detailed review [212] of the characteristics of the solution itself and of the associated vendor, and then scoring [214] and benchmarking [216] of solutions to identify a target list [220]. In one scenario, the vendor will optionally sign up to be listed on the website [235], which will result in agreement on commercial terms prior to listing [222]. Products may be listed and set up on the website without vendor agreement and sign up. If appropriate commercial terms are required, these will be agreed [224], then further information is gathered [226] and specific configurations are defined [228], which may for example fix the variables and costs associated with them. Lastly, these approved solutions are set up on the system [230] and used as part of the source of information from which recommendations are made to users.

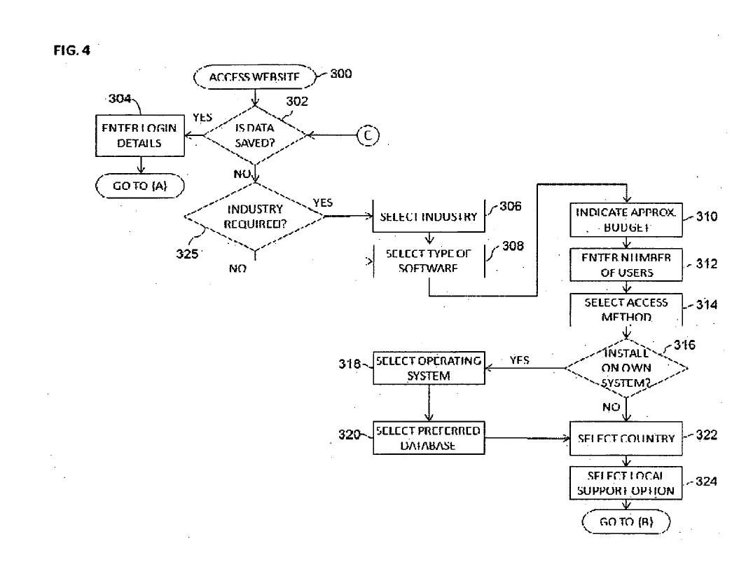

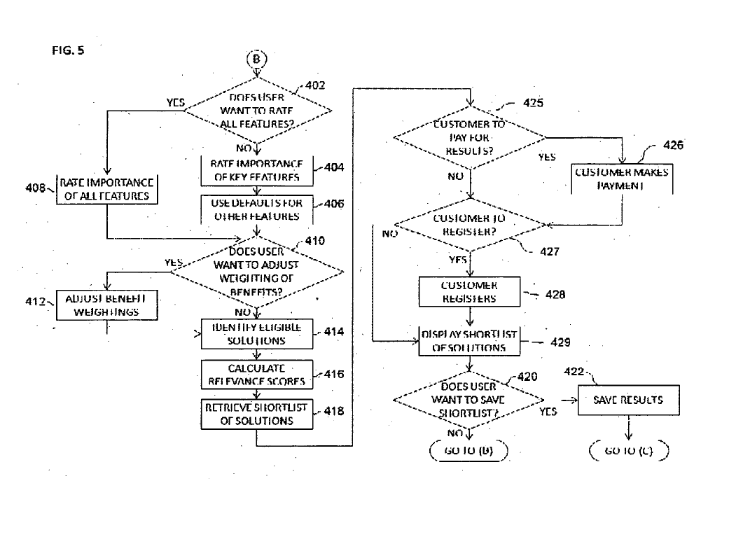

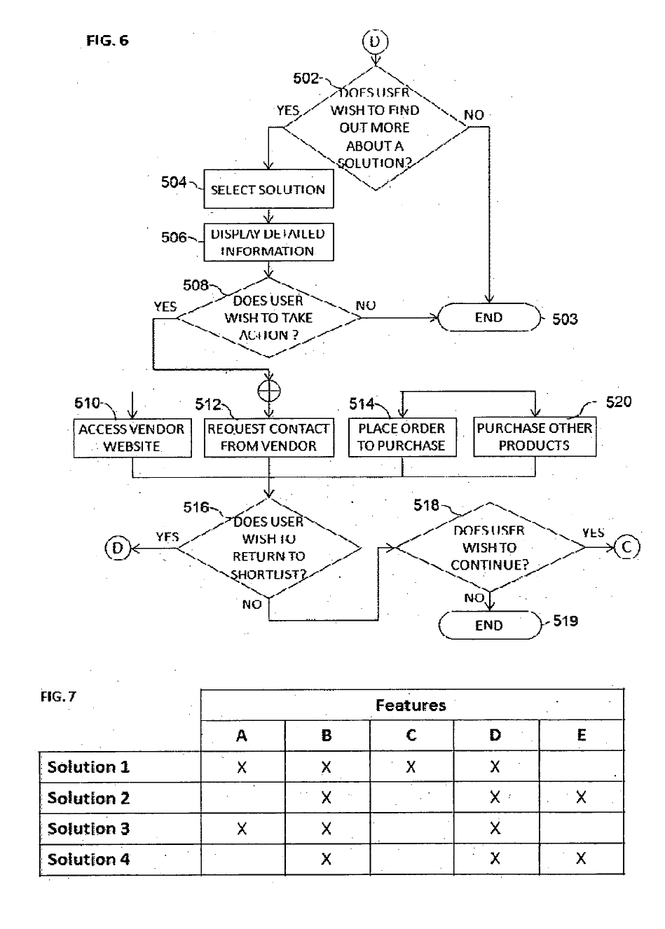

A flow chart is depicted in FIGS. 4, 5 and 6 of an example sequence of steps by which a user defines their requirements, receives a shortlist of relevant solutions, and reviews, and compares or otherwise takes action with regards to the recommended solutions.

In this example, a user starts a search by accessing a website [300], and deciding [302] whether to retrieve an existing shortlist of solutions [304] or start a new search by optionally [325] selecting the industry in which they operate [306] and selecting the type of software [308] which they wish to consider. The system may default an industry in and/or this may not be required. They proceed by indicating the approximate size or range of their budget [310], number of required users of the solution [312], and the nature of the usage or license rights [314]. If the user is seeking a solution to install on their own system, then additional questions may be asked about their operating system [318] and database [320] requirements. The user is then asked which country they reside in [322] and whether they require local support [324]. The system may default any of these parameters in while gathering information. Taken together, this section forms an assessment of the user's basic needs.

Additional assessment of user requirements and preferences is then possible, with the user able to decide how much additional information they wish to provide [402]. A selection of key features relevant to the type of software desired is displayed [404], each of which the user can rate as either mandatory, preferred, or irrelevant. Defaults are provided [406], so the user only has to adjust the ones they wish to change to a different setting. If desired, the user can choose to rate all features pertaining to the selected type of software [408]. Similarly, the user can choose [410] whether to adjust the relative importance of various software benefits [412], such as low cost, scalability, ease of use, and so on.

Having assembled an understanding of the user's requirements and preferences, the system now identifies a subset of solutions that meet at least the minimum requirements of the user [414], and for each of those solutions calculates a relevance score [416]. A shortlist consisting of a number of highly relevant solutions is then retrieved for the user [418]. The customer may be required to pay to view search results and/or conduct searches [425], in which case he/she will make the payment online in real time [426]. Alternatively, a customer may be required to register in order to view search results /conduct searches [427], in which case this will be done online in real time [428]. A shortlist of solutions will then be displayed in real time [429], together with high level information (including a comparison price) in a format designed for easy comparison of solutions. The user can save the shortlist for future retrieval [422] or choose a particular solution [504] to explore in more detail [506].

In some embodiments, the user may elect to request a search for software which is not in the database of solutions. This may be prompted by the user not being satisfied with the search results or it may be that the user requests such a search at the start. In these circumstances, the system of the invention may utilize search engine software to generate a further list of results which are outside the list in the database. In some instances, the user may adopt to have a manual search undertaken by a customer service representative who may undertake any required steps in order to make the search more effective. This may include a further interview with the user, contacting potential vendors, etc. Such a service may be conducted for a fee.

A range of information may then be displayed, including but not limited to detailed product descriptions, screenshots, brochures, demonstrations, videos, and user reviews. The user can also opt to take one or more actions, such as accessing the vendor website [510], requesting that the vendor contact them [512] for further discussions, or proCeeding to purchase their chosen solution [514]. If desired, they can choose to return to the shortlist [516] or start the search over again [518].

After conducting software comparison searches, a customer may elect to purchase additional products online [520], such as detailed product review and the like.

FIG. 7 illustrates the notion of “marginal features” which is used to identify a relatively small set of features for which user input can rapidly narrow down the set of eligible and relevant solutions. In this example, features B and D are common across the set of four solutions, while features A, C, and E are defined as marginal features because they are present in some but not all solutions. In one embodiment of the invention, the system identifies marginal features and for each of them calculates a percentage of solutions in which the feature is present. The lower the percentage of solutions in which the feature is present, the greater the chance of eliminating solutions if the feature is required by the user, but also the greater the risk that the feature may be unusual, confusing or irrelevant to the user. In practice, the system may assign a scoring method, for instance based on the proximity of this percentage to a pre-set target, in order to determine which features are likely to be most useful in quickly narrowing down to a subset of eligible and relevant solutions.

Another key element of the invention is the Comparison Price, which addresses an important deficiency in the prior art related to availability and comparability of pricing information. Here, a Comparison Price is defined as a single monetary amount that reflects all costs for a solution over a defined period of time, thus enabling easier comparison of solutions with different pricing structures and/or currencies. There are various methods for calculating a Comparison Price included in this patent, including but not limited to the use of Present Value (PV) methodologies to calculate an equivalent upfront cost for a solution that considers the time value of money, based on the following equation:

$$PV = \sum \frac{{C}_{t}}{{( 1 + {r}_{t} )}^{t}}$$

where t=time, measured in some unit such as months or years
cₜ=cash flow at time t
rₜ=interest rate or opportunity cost per unit of time

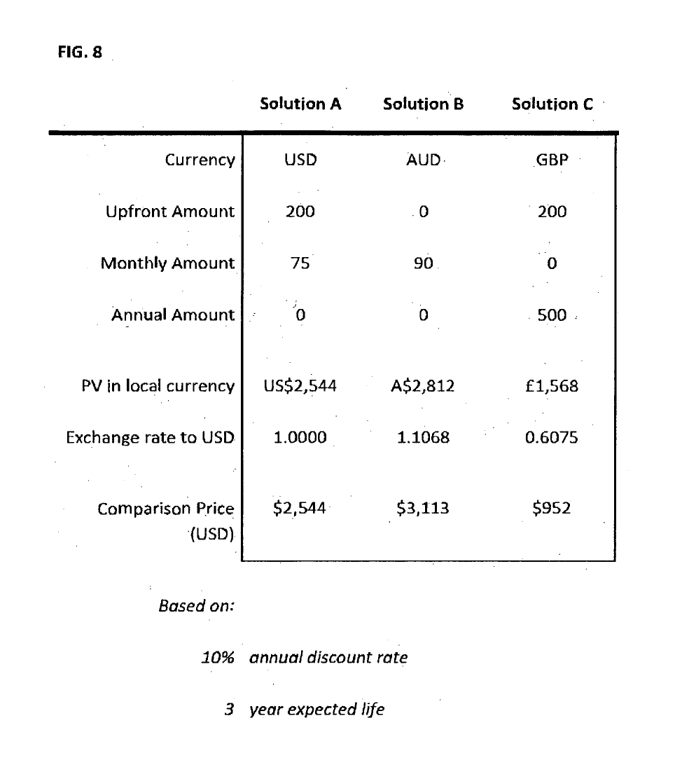

FIG. 8 illustrates how the Comparison Price, claimed in this invention, is practically applied. In the illustrated example, three sample solutions—solution A, B and C—are being compared. Solution A requires an upfront payment of USD$200 followed by a monthly subscription of USD$75 for the life of the solution. Solution B requires a monthly subscription of AUD$90 for the life of the solution. And solution C requires an upfront payment of GBP200 followed by an annual subscription of GBP500 for the life of the product. It is assumed that the expected life of these three solutions is 3 years. The costs of these solutions are to be compared over their expected life.

In order to work out an equivalent price, termed the ‘Comparison Price’ in this invention, the time value of money is used. A single cash flow is calculated that represents the Present Value of all payments made by the customer for (or cash flows relevant to) each solution over its expected life. This Present Value is calculated using the above PV calculation, at an annual discount rate of 10%, as shown in the ‘PV in local currency’ field in FIG. 8.

After calculating a single cash flow for each solution, an exchange rate conversion is applied to the amounts of each solution in order to bring them to a common currency (USD). It is then possible to compare the prices of these three solutions against each other, as a normalized ‘Comparison Price’ has been calculated for the solutions.

For the purposes of practical application of certain embodiments of this invention, the technical specifications of a typical machine on which this method of comparing a plurality of business solutions may be processed includes:
Virtual Private Server (VPS)
Intel Dual Xeon Gainestown Processor
512 MB SLM RAM Memory
5 GB RAID Drive
Linux/Unix operating system with Apache (or equivalent)
MySQL database (or equivalent)

These technical specifications may be seen as Minimum Technical Specifications'; however this would depend upon the system's loading requirements.

1: A method for comparing a plurality of business solutions comprising:
receiving one or more solution requirements from a user;
creating a subset of at least one solution based on the user's solution requirement(s) wherein:
the subset comprises a plurality of solutions further comprising the steps of;
prioritizing the solutions within the subset based on the fit of each to the user's solution requirements; and
optionally providing a means for the user to compare the selected solutions.

2-21. (canceled)

22: A method for comparing one or more entities, wherein the entities consist of any combination of software, hardware and IT services components and at least one solution contains two or more associated cost installments, the method comprising:
representing each solution as a solution of at least one of the software, hardware and IT services components, and optionally wherein the configuration of the solution defines all cost-dependent variables for each solution;
representing the cost of each solution as a single amount, wherein the amount reflects all cost installments of the solution over the period of time;
calculating or retrieving the amounts for at least one of a set of the entities; and
comparing or benchmarking the amounts for one or more of the entities.

23-37. (canceled)

38: A method for comparing a set of business solutions comprising real-time identification of a subset of relevant solutions.

39-41. (canceled)

42: A system for comparing a plurality of business solutions comprising:
a user interface;
a module to gather solution requirements from a user;
a module to create a subset of at least one solution based on the user's solution requirements;
a module to prioritize the solutions within the subset based on the fit of each to the user's solution requirements; and
optionally a module to provide a means for the user to compare the selected solutions.

43: A system for comparing one or more entities, wherein the entities comprise any combination of software, hardware and IT services components and at least one solution contains two or more associated cost installments, the system comprising:
a user interface;
a module to calculate cost information as herein described; and
a module to compare or benchmark the amounts for any number of the entities.

44: A system for comparing a set of business solutions comprising a module to perform real-time identification of a subset of relevant solutions.

45: A system for comparing a set of business solutions comprising a module to generate for a subset of solutions a single comparison cost that reflects for each member of the subset all relevant costs over a period of time.

46-52. (canceled)
